(19) United States
(12) Patent Application Publication
(10) Pub. No.: US 2007/0133021 A1
(43) Pub. Date: Jun. 14, 2007

(54) Image generation apparatus and method of generating color gamut information thereof, and image playback apparatus and method of detecting color gamut information thereof

(75) Inventors: Chang-woo Lee, Suwon-si (KR); Moon-cheol Kim, Suwon-si (KR); Sang-jin Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/509,569

(22) Filed: Aug. 25, 2006

(30) Foreign Application Priority Data
Dec. 9, 2005 (KR) 10-2005-0120676

(51) Int. Cl. H04N 1/60

(52) U.S. Cl. 358/1.9

(57) ABSTRACT

An image generation apparatus and a method of generating a color gamut information thereof, and an image playback apparatus and a method of detecting a color gamut information thereof are provided. The image generation apparatus includes a format converting unit converting a video stream from a first format into a second format; a color gamut information encoding unit encoding color gamut information in a section of the video stream ; and an output stream generating unit generating an output stream by combining the encoded information with the video stream. The image playback apparatus includes a stream inputting unit inputting a video stream encoded with color gamut information; a color gamut information decoding unit; a color gamut mapping unit mapping a color gamut of the video stream; and an image signal playback unit processing and playing back the video stream.

### CROSS-REFERENCE TO RELATED APPLICATIONS

This application priority from Korean Patent Application No. 2005-120676, filed Dec. 9, 2005, in the Korean Intellectual Property Office, the entire contents of which is incorporated herein by reference.

### BACKGROUND OF THE INVENTION

1. Field of the Invention

Apparatuses and methods consistent with the present invention relate to generating color gamut information and detecting color gamut information, and more particularly, to encoding color gamut information in a blank area of a video stream and outputting the color gamut information, and to detecting the color gamut information in a blank area of a video stream and generating image data.

2. Description of the Related Art

Generally, an image generation apparatus such as a camcorder or a digital still camera (DSC) generates and outputs a video stream, and an image playback apparatus such as a television or a digital multimedia broadcasting (DMB) receives the video stream and plays back the video stream on a screen.

FIG. 1 is a view of a structure of a related art image generation apparatus.

Referring to FIG. 1, the conventional image generation apparatus includes an image sourcing unit 10, a gamma compensating unit 20, a format converting unit 30, a color gamut mapping unit 40, and an outputting unit 50.

The image sourcing unit 10 outputs linear red-green-blue (RGB) data created by photographing. The gamma compensating unit 20 compensates a gamma with respect to the linear RGB data in consideration of characteristic changes generated in playback of the linear RGB data. The linear RGB data which has the gamma compensation is output as non-linear RGB data, and the format converting unit 30 converts a format of the non-linear RGB data and outputs image data in a YCbCr format.

The color gamut mapping unit 40 maps a color gamut with respect to the image data in the YCbCr format in order for an optimum color to be reproduced in playback of the image data. The outputting unit 50 encodes the image data in the YCbCr format which is output from the color gamut mapping unit 40 with a synchronization signal (sync), and outputs a component or composite video stream such as ITU-R.BT.656, SMPTE-274M or SMPTE-292M.

FIGS. 2A and 2B are views of a video stream output from a related art image generation apparatus.

FIG. 2A is a view of ITU-R.BT.656 video stream output from the conventional image generation apparatus, and FIG. 2B is a view of SMPTE-274M video stream output from the conventional image generation apparatus.

An image playback apparatus (not shown) receives the video stream illustrated in FIGS. 2A and 2B, and outputs the video as an image on a screen. Recently, an image playback apparatus is required to have a wide color gamut for expressing various colors. However, there is no standardized way of encoding for using the wide color gamut in an image generation apparatus, and no way of outputting a video stream with respect to the expanded color gamut.

When outputting the video stream of the wide color gamut, the image playback apparatus has no way of decoding and playing back the video stream of the wide color gamut. Therefore, the conventional image playback apparatus fails to reproduce the optimum color.

### SUMMARY OF THE INVENTION

An aspect of the present invention is to provide an image generation apparatus which encodes color gamut information with respect to an existing color gamut and an expanded color gamut, and combines the color gamut information with a video stream.

Another aspect of the present invention is to provide an image playback apparatus which detects color gamut information from a video stream including a color gamut information, and playing back an image in an optimum color.

Yet another aspect of the present invention is to provide an image playback apparatus which judges whether to expand a color gamut of a video steam not included with color gamut information and plays back an image in an optimum color.

In order to achieve the above and other aspects of the present invention, there is provided an image generation apparatus comprising a format converting unit converting a video stream in a first format into a video stream in a second format; a color gamut information encoding unit encoding a color gamut information in a predetermined section of the video stream in the second format; and an output stream generating unit generating an output stream combining the encoded color gamut information with the video stream in the second format.

The format converting unit may convert the video stream in the first format into the video stream in the second format corresponding to at least one of an sRGB color gamut, an sYCC color gamut and an xvYCC color gamut, according to a color gamut of the video stream in the first format.

The video stream in the first format may be a video stream in a gamma-compensated RGB format, and the video stream in the second format may be a video stream in a YCbCr format.

The color gamut information encoding unit may encode the color gamut information in a blank section of the video stream in the YCbCr format.

The color gamut information encoding unit may change a Y value of the blank section into a lowest luminance value, so that the black section of the video stream in the YCbCr format, the blank section encoded with the color gamut information, is displayed in black in a screen.

The color gamut information encoding unit may convert the color gamut information into a restorable color gamut code form such as an American standard code for information interchange (ASCII) code, and may encode the converted color gamut information in video stream in the YCbCr format.

The image generation apparatus may further include an error bit generating unit generating an error bit confirming an error of the color gamut information.

The error bit generating unit may insert one of a parity bit and a Hamming code, in the last place of the color gamut information encoded in the video stream of the second format, and may generate the error bit for to confirm the error.

The image generation apparatus may further include a color gamut value storing unit storing a coordinate value corresponding to a vertex of the sRGB color gamut.

The output stream constituting unit may correct the coordinate value stored in the color gamut value storing unit to correspond to a color gamut of the video stream in the second format, and may add the corrected coordinate value into the output stream, if the color gamut of the video stream in the second format is at least one of the sYCC color gamut and the xvYCC color gamut.

In order to achieve the above and other aspects of the present invention, there is provided an image generation apparatus comprising an image playback apparatus comprising a stream inputting unit inputting a video stream encoded with a color gamut information; a color gamut information decoding unit decoding the color gamut information encoded in the video stream; a color gamut mapping unit mapping color gamut of the video stream by use of the color gamut information; and an image signal playback unit signal-processing the mapped video stream and playing back the signal-processed video stream.

The image playback apparatus may further comprise an error bit detecting unit detecting an error bit for confirming an error of the color gamut information.

The stream inputting unit may receive at least one of an sRGB color gamut, an sYCC color gamut and an xvYCC color gamut.

The color gamut information decoding unit may decode the color gamut information encoded in a blank section of the video stream.

The color gamut mapping unit may judge whether to expand the color gamut information according to a color distribution of an image data included in the video stream, if a video stream not encoded with the color gamut information is input through the stream inputting unit.

The color gamut mapping unit may judge that the color gamut information is expanded to at least one of the sYCC color gamut and the xvYCC color gamut, if of the image data included in the video stream, the number of the image data away from the sRGB color gamut is equal or more than a rate.

In order to achieve the above and other aspects of the present invention, there is provided an image generation apparatus comprising a method of generating a color gamut information comprising converting a video stream in a first format into a video stream in a second format; encoding a color gamut information in a section of the video stream in the second format; and generating an output stream combining the encoded color gamut information with the video stream in the second format.

In the operation of converting the video stream, the video stream in the first format may be converted into the video stream in the second format corresponding to at least one of an sRGB color gamut, an sYCC color gamut, and an xvYCC color gamut, according to a color gamut of the video stream in the first format.

In the operation of encoding the color gamut information in a section of the video stream, the color gamut information may be converted into a restorable code form such as an American standard code for information interchange (ASCII) code in a blank section of the video stream in the second format, and may be encoded.

The video stream in the first format may be a video stream in a gamma-compensated RGB format, and the video stream in the second format may be a video stream in a YCbCr format.

A Y value of the blank section may be changed into a lowest luminance value, so that the black section of the video stream in the YCbCr format, the blank section encoded with the color gamut information, is displayed in black in a screen.

A coordinate value corresponding to a vertex of the sRGB color gamut may be corrected to correspond to a color gamut of the video stream in the second format, and may be added in the output stream, if the video stream in the second format is at least one of the sYCC color gamut and the xvYCC color gamut.

In order to achieve the above and other aspects of the present invention, there is provided an image generation apparatus comprising a method of detecting a color gamut information comprising receiving a video stream encoded with a color gamut information; decoding the color gamut information encoded in the video stream; mapping a color gamut of the video stream, by use of the color gamut information; and signal-processing the mapped video steam and playing back the signal-processed video signal.

It may be judged whether to expand the color gamut information according to a color distribution of an image data included in the video stream, if the video stream where the color gamut information is not encoded, is input.

It may be judged that the color gamut information is expanded to at least one of an sYCC color gamut and an xvYCC color gamut, if of the image data included in the video stream, the number of the image data away from an sRGB color gamut is equal or more than a predetermined rate.

### BRIEF DESCRIPTION OF THE DRAWING FIGURES

The above and other aspects of the present invention will become more apparent by describing in detail exemplary embodiments thereof with reference to the attached drawing figures, wherein;

FIG. 1 is a view of a structure of a related art image generation apparatus;

FIGS. 2A and 2B are views of a video stream output from a related art image generation apparatus;

FIG. 3 shows a schematic structure of an image generation apparatus according to an exemplary embodiment of the present invention;

FIG. 4 shows a location of a color gamut information on a screen according to an exemplary embodiment of the present invention;

FIGS. 5A through 5C are views provided to explain a method of encoding color gamut information of the image generation apparatus according to an exemplary embodiment of the present invention;

FIG. 6 shows a schematic structure of an image playback apparatus according to an exemplary embodiment of the present invention;

FIG. 7 is a view provided to explain a method of judging a color gamut of an image playback apparatus according to an exemplary embodiment of the present invention;

FIG. 8 is a flowchart provided to explain a method of generating the color gamut information of an image generation apparatus according to an exemplary embodiment of the present invention; and

FIG. 9 is a flowchart provided to explain a method of detecting color gamut information of an image playback apparatus according to an exemplary embodiment of the present invention.

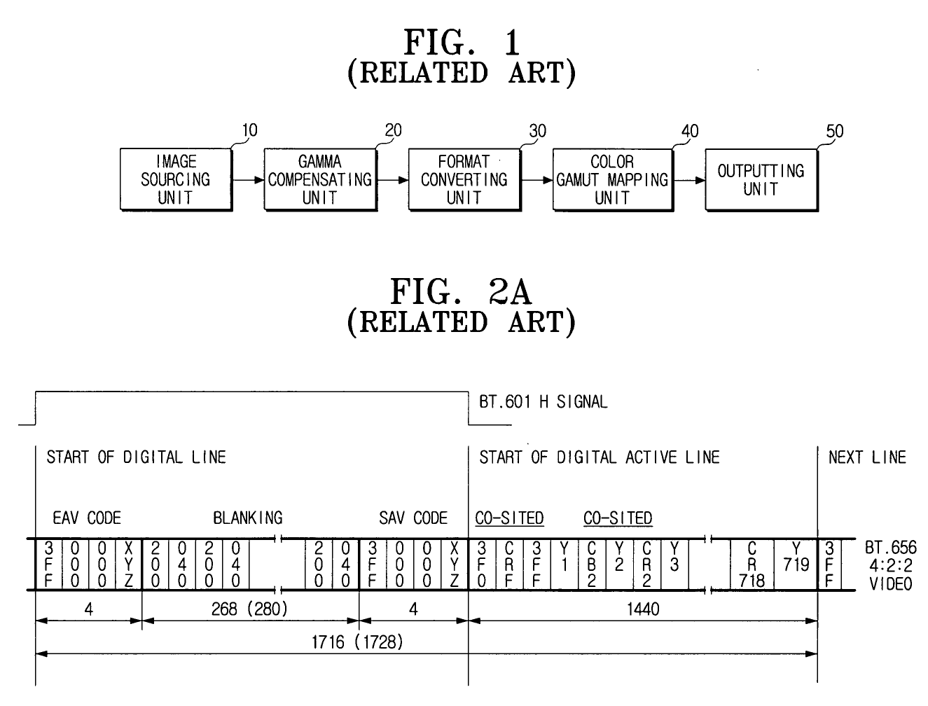

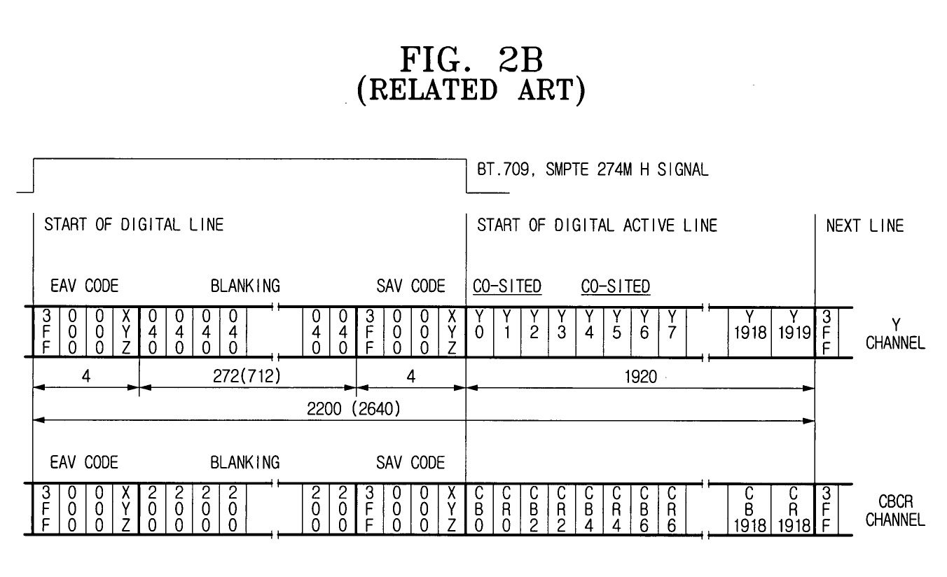

### DETAILED DESCRIPTION OF EXEMPLARY EMBODIMENTS OF THE PRESENT INVENTION

Hereinafter, exemplary embodiments of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

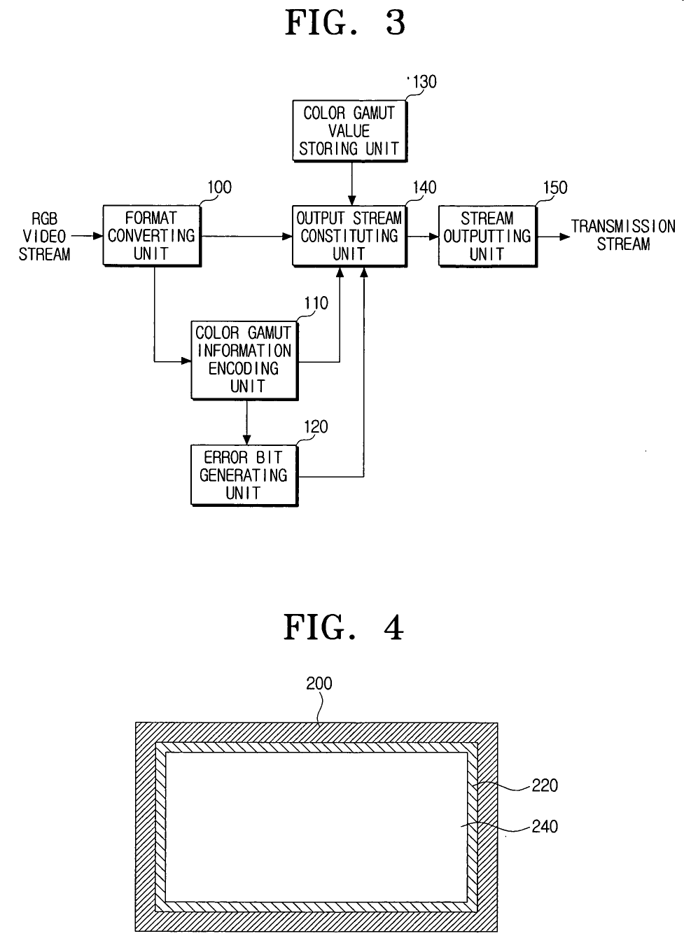

FIG. 3 shows a schematic structure of an image generation apparatus according to an exemplary embodiment of the present invention.

Referring to FIG. 3, the image generation apparatus includes a format converting unit 100, a color gamut information encoding unit 110, an error bit generating unit 120, a color gamut value storing unit 130, an output stream constituting unit 140 and a stream outputting unit 150.

The format converting unit 100 converts an input video stream in a gamma compensated RGB format into a video stream in YcbCr format. If the video stream in the RGB format has a standard RGB (sRGB) color gamut, the video stream in the RGB format is output as a video stream in a standardized YcbCr format. If the video stream in the RGB format has a standard YCC (sYCC) color gamut or an expanded video YCC (xvYCC) color gamut, the video stream in the RGB format is output as a video steam of expanded YCbCr through an sYCC matrix or an xvYCC matrix.

The color gamut information encoding unit 110 encodes color gamut information in a blank section or an unused section of the video stream which is output from the format converting unit 100. That is, the color gamut information encoding unit 110 encodes an ASCII code corresponding to “sRGB” in the blank section, if a color gamut format of a video stream output by the format converting unit 100 is sRGB. In the same way, if the color gamut format of the video stream output by the format converting unit 100 is sYCC, the ASCII code corresponding to “sYCC” is encoded in the blank section, and if the color gamut format of the video stream output by the format converting unit 100 is xvYCC, the ASCII code corresponding to “xvYCC” is encoded in the blank section. In addition to the ASCII code, all the restorable codes are usable. The color gamut information can be encoded in the video stream of the YCbCr format as well as in the video stream of the RGB format which is not converted on the format concerting unit 100.

The error bit generating unit 120 generates an error bit for investigating an error with respect to the color gamut information encoded from the color gamut information encoding unit 110. More particularly, it is possible to confirm the bit error by inserting information such as a parity bit or a Hamming code or other such information known in the art into a last place of the color gamut information encoded in the video stream in the YCbCr format. The error bit generating unit 120 confirms an even or odd parity bit with respect to the entire ASCII codes, or the even or odd parity bit with respect to an individual ASCII code.

If a Hamming code is used for transmission of the more accurate color gamut information, in detecting an error caused by the Hamming code is detected, the error may be corrected and transmitted, or the error may be ignored and the color gamut information corresponding to a previous frame may be re-transmitted:

The color gamut value storing unit 130 is stored with coordinate values corresponding to each of the vertexes of the sRGB color gamut. The coordinate values stored in the color gamut value storing unit 130 are used for mapping the color gamut.

The output stream constituting unit 140 generates an output stream combining the color gamut information and the error bit into the video stream in the YCbCr format. That is, the color gamut information and the error bit encoded in the blank section of one frame are combined into the video stream in the YCbCr format. Also, if the video stream in the YCbCr format has the expanded color gamut (sYCC or xvYCC), the coordinate values stored in the color gamut value storing unit 130 are added in the output stream.

The stream outputting unit 150 encodes the output stream output from the output stream constituting unit 140 with the sync, and outputs the encoded stream as a transmission stream in ITU-R.BT.601, ITU-R.BT.656, ITU-R.BT.709, SMPTE-274M or SMPTE-292M.

FIG. 4 shows a location of color gamut information on a screen according to an exemplary embodiment of the present invention.

Referring to FIG. 4, color gamut information is located in a blank section 200 and not displayed on a screen. Even when a Y value is encoded as a lowest value and the color gamut information is located not in the blank section 200 but in an efficient data section 220, the color gamut information is not displayed in a screen, because it is possible to display image data in an image displaying section 240 and an efficient data section 220 according to a type of an image playback apparatus.

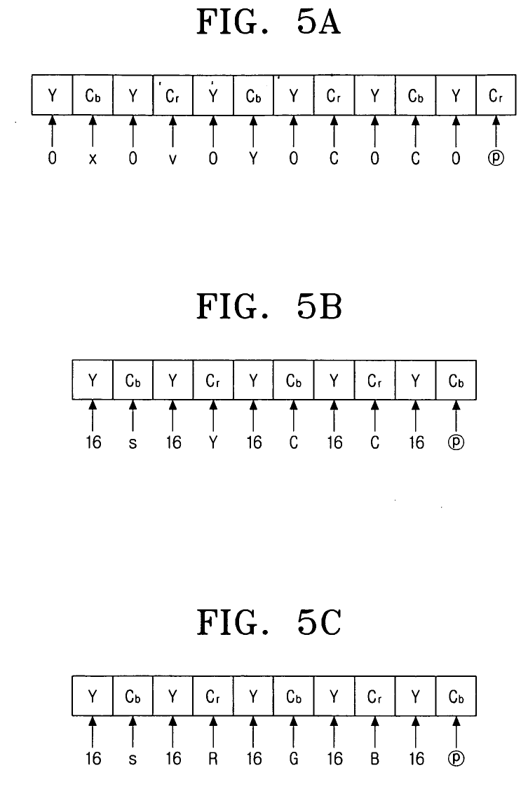

FIGS. 5A through 5C are views provided to explain a method of encoding color gamut information of an image generation apparatus according to an exemplary embodiment of the present invention.

FIG. 5A is a view of the method of encoding a color gamut information, if a video stream in a YcbCr format has an xvYCC color gamut. As illustrated in 5A, a Y value is encoded as “0” for image data not to be displayed in a screen, and color difference signal (Cb and Cr) values are encoded as an ASCII code corresponding to “xvYCC”. A last place of xvYCC” is added with a parity bit for an error inspection. Or, the parity bit is added in “x”, “v”, “Y”, and“C”, respectively for the error inspection (not shown).

FIG. 5B shows the method of encoding color gamut information, if the video stream in the YcbCr format has an sYCC color gamut, and FIG. 5C shows the method of encoding a color gamut information, if the video stream in the YcbCr format has an sRGB color. As illustrated in FIGS. 5B and 5C, the Y value is encoded as “16” for the image data not to be displayed in the screen, and the color difference value is encoded as the ASCII code corresponding to “sYCC” or “sRGB”. The sYCC and sRGB color gamuts ranges from 16 to 235 and the xvYCC color gamut ranges from 0 to 255, so there is a difference between lowest values encoded in the Y value. The error bit of FIGS. 5B and 5C is generated in the same method as FIG. 5A.

FIG. 6 shows a schematic structure of an image playback apparatus according to an exemplary embodiment of the present invention.

Referring to FIG. 6, the image playback apparatus of the present invention includes a stream inputting unit 300, a color gamut information decoding unit 310, an error bit detecting unit 120, a color gamut mapping unit 350, and an image signal playback unit 370.

The stream inputting unit 300 receives a video steam output from an image generation apparatus. The image generation apparatus may be predetermined. The stream inputting unit 300 receives a video steam in a YCbCr format including color gamut information corresponding to at least one of an sRGB, an sYCC and an xvYCC, or receives a video stream where the color gamut information is not encoded.

If the color gamut information is included in the video stream input through the stream inputting unit 300, the color gamut information decoding unit 310 decodes color gamut information encoded in a blank section of the video stream.

The error bit detecting unit 330 detects an error at a last place of the color gamut information encoded in the video stream

If the video stream including the color gamut information is input through the stream inputting unit 300, the color gamut mapping unit 350 maps the color gamut of the video stream by use of the color gamut information decoded by the color gamut information decoding unit 310 and the error bit output by the error bit generating unit 120.

If a video stream not including the color gamut information is input through the stream inputting unit 300, the color gamut mapping unit 350 judges whether to expand the color gamut information according to a color distribution of image data included in the video stream. More particularly, if the number of image data away from a range of an sRGB included in the video stream, is equal or more than a certain rate, the color gamut gamut mapping unit 350 judges that the color gamut information is expanded to at least one of an sYCC and an xvYCC. The certain rate may be predetermined.

The image signal playback unit 370 signal-processes the video stream to display the best image on a screen according to a result of judgment by the color gamut mapping unit 350.

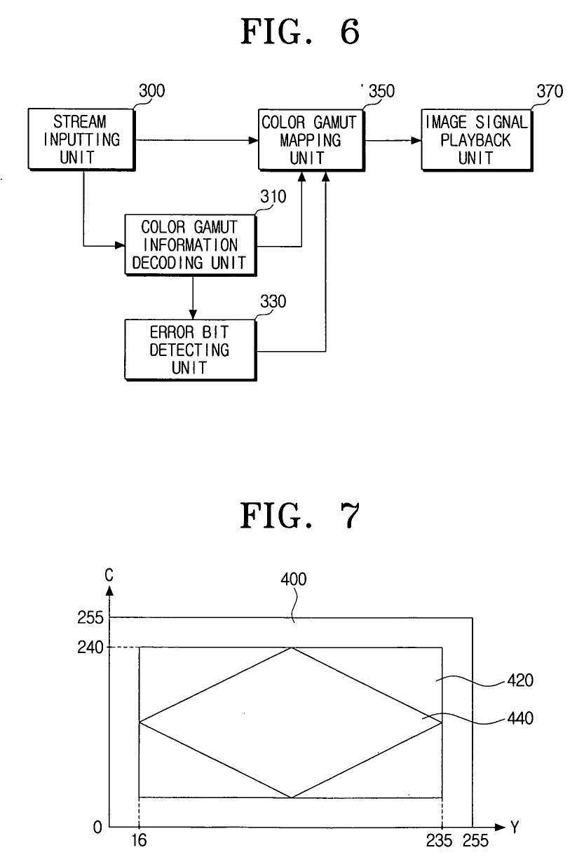

FIG. 7 is a view provided to illustrate a method of judging a color gamut of an image playback apparatus according to an exemplary embodiment of the present invention.

Referring to FIG. 7, a color gamut mapping unit 350 detects a color distribution of an image data included in a video stream to judge whether to expand color gamut information. That is, the number of image data included in an sYCC color gamut 420 or an xvYCC color gamut 400 away from an sRGB color gamut 440 is counted and if the number of counted image data is equal or more than a certain rate, it is judged that a color gamut is expanded. That is, it is judged that the color gamut of the video stream is the sYCC color gamut 420 or the xvYCC color gamut 400.

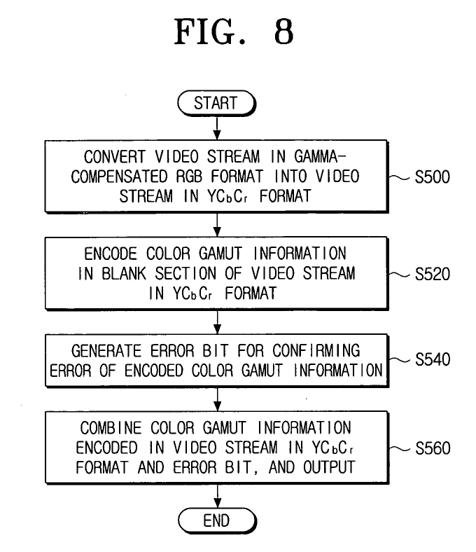

FIG. 8 is a flowchart provided to explain a method of generating a color gamut information of an image generation apparatus according to an exemplary embodiment of the present invention.

Referring to FIG. 8, a video stream in a gamma compensated RGB format is converted into a video stream in a YCbCr format by the format converting unit 100. Output is the video stream in the YCbCr format having at least one color gamut of an sRGB, an sYCC and an xvYCC according to the color gamut of the video stream in the RGB format (S500).

Color gamut information is encoded in a blank section of the video stream in the YCbCr format by the color gamut information encoding unit 110. That is, a Y value in a blank section not displayed in a screen is encoded as “0” if the color gamut of the video stream is in the sRGB color gamut or the sYCC color gamut, and is encoded as “16” if the video stream of the color gamut is in the xvYCC. An ASCII code corresponding to each color gamut is encoded in a color difference signal value in the blank section (S520).

An error bit is generated for an error confirmation in the encoded color gamut information by the error bit generating unit 120. A last place of the color gamut information is inserted with a parity bit or Hamming code (S540).

The color gamut information encoded in the video stream in the YCbCr format is combined with the error bit and output by output stream constituting unit 140. If the color gamut of the video stream in the YCbCr format has the sYCC color gamut or the xvYCC color gamut, coordinate values corresponding to each of the vertexes of the sRGB color gamut are added in an output stream (S560).

In the abovementioned method, the video stream including the color gamut information is generated.

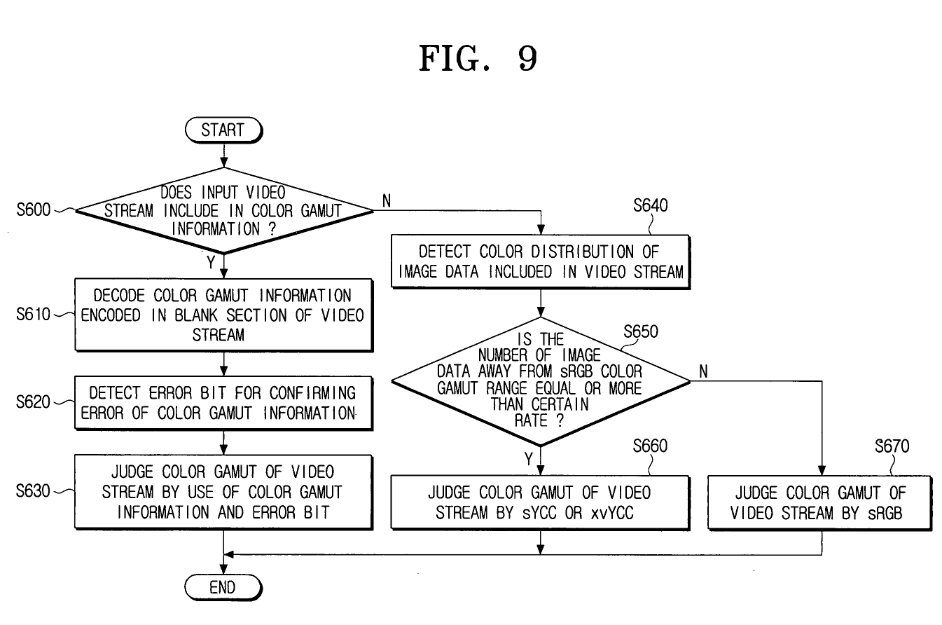

FIG. 9 is a flowchart provided to explain a method of detecting color gamut information of an image playback apparatus according to an exemplary embodiment of the present invention.

Referring to FIG. 9, the steam inputting unit 300 judges if an input video stream includes color gamut information (S600).

If the video steam includes with the color gamut information, the color gamut information decoding unit 310 decodes the color gamut information encoded in a blank section of the video stream (S610).

The error bit detecting unit 330 detects an error in the color gamut information (S620), and the color gamut mapping unit 350 judges the color gamut of the video stream by use of the color gamut information and the error bit (S630).

If the video stream not including the color gamut information is input, the color gamut mapping unit 350 detects a color distribution of image data included in the video stream (S640), and counts the number of the image data away from a range of an sRGB color gamut. When the number of the counted image data reaches equal or more than a certain rate (S650), the color gamut of the video stream is judged to be an sYCC or an xvYCC (S660), and if the number of the counted image data is equal to or less than the certain rate, the color gamut of the video stream is judged to be the sRGB (S670).

An image, having an optimum color based on a color gamut judged by the above process, is displayed on a screen.

As abovementioned, according to an exemplary embodiment of the present invention, color gamut information with respect to an existing color gamut and an expanded color gamut is encoded, the encoded color gamut information is detected and an image data is generated, so that an image is expressed in an optimum color. Also, it is judged whether to expand the color gamut with respect to a video stream not including the color gamut information, and image data generated by an existing image generation apparatus is processed, so that an optimum image is provided on screen to a user.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image generation apparatus comprising:
a color gamut information encoding unit which is configured to encode color gamut information in a section of the video stream having a format; and
an output stream generating unit which is configured to generate an output stream by combining the encoded color gamut information with the video stream in the format.

2. The image generation apparatus of claim 1, wherein the section is a blank section.

3. An image generation apparatus of claim 1, further comprising:
a format converting unit which is configured to convert a video stream having a first format into a video stream having a second format.

4. The image generation apparatus of claim 3, wherein the format converting unit converts the video stream having the first format into the video stream having the second format corresponding to at least one of an sRGB color gamut, an sYCC color gamut and an xvYCC color gamut.

5. The image generation apparatus of claim 3, wherein the corresponding color gamut is selected according to a color gamut of the video stream having the first format.

6. The image generation apparatus of claim 3, wherein the first format is a gamma-compensated RGB format.

7. The image generation apparatus of claim 3, wherein the second format is a YCbCr format.

8. The image generation apparatus of claim 7, wherein the color gamut information encoding unit encodes the color gamut information in a blank section of the video stream having the YCbCr format.

9. The image generation apparatus of claim 3, wherein the color gamut information unit encodes the color gamut information in an unused section of the video stream having the second format.

10. The image generation apparatus of claim 8, wherein the color gamut information encoding unit changes a Y value of the blank section into a lowest luminance value, so that the blank section of the video stream having the YCbCr format is displayed in black in a screen.

11. The image generation apparatus of claim 10, wherein the color gamut information encoding unit converts the color gamut information into a restorable color gamut code form, and encodes the converted color gamut information in the video stream having the YCbCr format.

12. The image generation apparatus of claim 11, wherein the restorable color gamut code form is American standard code for information interchange.

13. The image generation apparatus of claim 1, further comprising:
an error bit generating unit which is configured to generate an error bit confirming an error of the color gamut information.

14. The image generation apparatus of claim 13, wherein the error bit generating unit inserts one of a parity bit and a Hamming code in the last place of the color gamut information encoded in the video stream having the second format, and generates the error bit to confirm the error.

15. The image generation apparatus of claim 1, further comprising:
a color gamut value storing unit which is configured to store a coordinate value corresponding to a vertex of the sRGB color gamut.

16. The image generation apparatus of claim 15, wherein the output stream constituting unit corrects the coordinate value stored in the color gamut value storing unit to correspond to a color gamut of the video stream having the second format, and adds the corrected coordinate value into the output stream, if the video stream having the second format is at least one of the sYCC color gamut and the xvYCC color gamut.

17. An image playback apparatus comprising:
a stream inputting unit which is configured to input a video stream encoded with a color gamut information;
a color gamut information decoding unit which is configured to decode the color gamut information encoded in the video stream;
a color gamut mapping unit which is configured to map a color gamut of the video stream using the color gamut information; and
an image signal playback unit which is configured to process the mapped video stream and playback the processed video stream.

18. The image playback apparatus of claim 17, further comprising:an error bit detecting unit which is configured to detect an error bit for confirming an error of the color gamut information.

19. The image playback apparatus of claim 17, wherein the stream inputting unit receives at least one of an sRGB color gamut, an sYCC color gamut and an xvYCC color gamut.

20. The image playback apparatus of claim 17, wherein the color gamut information decoding unit decodes the color gamut information encoded in a blank section of the video stream.

21. The image playback apparatus of claim 17, wherein the color gamut mapping unit judges whether to expand the color gamut information according to a color distribution of image data included in the video stream, if the input video stream is not encoded with color gamut information.

22. The image playback apparatus of claim 21, wherein the color gamut mapping unit judges that the color gamut information is expanded to at least one of the sYCC color gamut and the xvYCC color gamut, if, of the image data included in the video stream, the number of the image data away from the sRGB color gamut is equal to or more than a certain rate.

23. A method of generating color gamut information comprising:
encoding color gamut information in a section of the video stream having a format; and
generating an output stream combining the encoded color gamut information with the video stream having the format.

24. The method of claim 23, further comprising:
converting a video stream having a first format into a video stream having a second format.

25. The method of claim 24, wherein in converting the video stream, the video stream having the first format is converted into the video stream having the second format corresponding to at least one of an sRGB color gamut, an sYCC color gamut, and an xvYCC color gamut.

26. The method of claim 25, wherein the color gamut is selected according to a color gamut of the video stream having the first format.

27. The method of claim 24, wherein in encoding the color gamut information, the color gamut information is converted into a restorable code form in a blank section of the video stream having the second format, and encoded.

28. The method of claim 27, wherein the restorable code form is an American Standard code for information interchange code.

29. The method of claim 24, wherein the first format is a gamma-compensated RGB format.

30. The method of claim 24, wherein the second format is a YCbCr format.

31. The method of claim 30, wherein a Y value of the section is changed into a lowest luminance value, so that the section of the video stream having the YCbCr format, the section encoded with the color gamut information, is displayed in black in a screen.

32. The method of claim 25, wherein a coordinate value corresponding to a vertex of the sRGB color gamut is corrected to correspond to a color gamut of the video stream having the second format, and added in the output stream, if the video stream having the second format is at least one of the sYCC color gamut and the xvYCC color gamut.

33. A method of detecting color gamut information comprising:
receiving a video stream encoded with a color gamut information;
decoding the color gamut information encoded in the video stream;
mapping a color gamut of the video stream, by use of the color gamut information;
processing the mapped video steam; and
playing back the processed video stream.

34. The method of claim 33, wherein it is judged whether to expand gamut information according to a color distribution of an image data included in a video stream, if the video stream not having color gamut information encoded, is input.

35. The method of detecting a color gamut information of claim 34, wherein it is judged to expand the color gamut information to at least one of an sYCC color gamut and an xvYCC color gamut, if of the image data included in the video stream, the number of the image data away from an sRGB color gamut is equal to or more than a certain rate.

36. A method comprising:
receiving a video stream;
if the video stream does not have color gamut information encoded, judging whether to expand color gamut information according to a color distribution of image data included in the video stream.
